(19) United States
(12) Patent Application Publication
(10) Pub. No.: US 2022/0366434 A1
(43) Pub. Date: Nov. 17, 2022

(54) METHOD AND SYSTEM FOR PRODUCT ANTI-COUNTERFEITING VERIFICATION MECHANISM

(71) Applicant: Lien Hao Chuang, Kaohsiung (TW)

(72) Inventor: Lien Hao Chuang, Kaohsiung (TW)

(21) Appl. No.: 17/869,302

(22) Filed: Jul. 20, 2022

(30) Foreign Application Priority Data
Jan. 28, 2021 (TW) 111104214

(51) Int. Cl. G06Q 30/00; G06Q 30/02; G06K 7/14

(52) U.S. Cl. CPC G06Q 30/0185; G06Q 30/0278; G06K 7/1413; G06K 7/1417

(57) ABSTRACT

A method and a system for a product anti-counterfeiting verification mechanism which is composed of a server, a user interface, a first information device, and a second information device. The image of the product can be captured by the first information device. After segmentation, coding, and selecting a plurality of segmented grid images and their codes, they are further encrypted to generate a product code, which is attached to the product. When the verification is required, the product code is captured and analyzed. Meanwhile, the image of the product to be verified is captured. The corresponding standard grid image is extracted from the product code and compared against the grid image of the product to be verified. In this way, it is ensured that the product is genuine from the time of posting to the time of pickup.

### BACKGROUND OF INVENTION

### (1) Field of the Present Disclosure

The present disclosure relates to a method and a system for a product anti-counterfeiting verification mechanism, in particular to a method of using image processing technology to convert a standard image of a product into a product-representing code. When the verification is required, the information is extracted from the product-representing code of the image of the product to be verified for comparison to ensure that the product is a genuine one.

### (2) Brief Description of Related Art

At present, the anti-counterfeiting technology of products on the market mainly uses anti-counterfeiting labels as identification. However, anti-counterfeiting features usually cannot be added to the product itself. If the unscrupulous person removes the anti-counterfeiting label and attaches it to the counterfeit product, it will still allow the unscrupulous person to achieve the purpose of confounding the real thing. As a result, anti-counterfeiting labels cannot effectively achieve the purpose of identifying genuine products and preventing counterfeiting. Accordingly, how to ensure that the products are genuine from the shelf sale to the customer's purchase is an urgent problem to be solved.

### SUMMARY OF INVENTION

It is a primary object of the present disclosure to provide a method and a system for a product anti-counterfeiting verification mechanism through which a product code obtained by using the image encryption/decryption technology. Meanwhile, a standard image of the product is compared against the image of the product to be verified through the product code to ensure that the product is genuine.

According to the present disclosure, a system for a product anti-counterfeiting verification mechanism includes a server, a product trading platform, a first information device, and a second information device. The first information device captures a standard image of a product in advance. A product code is assigned to each of the grid images. Each product code and its corresponding grid image can be randomly selected by means of random numbers. Thereafter, a product code is generated and attached to the product in the form of a digital label. When the authenticity verification is required, the product code is extracted through the second information device and transmitted to the server. In this way, it is possible to quickly and effectively perform image recognition to confirm the authenticity of the product. In addition, since the images are segmented and randomly sampled and compared, it will greatly increase the difficulty of counterfeiting and have good identification efficiency. In this way, it is ensured that the product is genuine from the time of launching for sale to the time of pickup by the customer.

### BRIEF DESCRIPTION OF THE DRAWINGS

FIG. 1 is a block diagram of the system according to the present disclosure;

FIG. 2 is a flow chart I of the method according to the present disclosure;

FIG. 3 is an implementation view I of the present disclosure;

FIG. 4 is an implementation view II of the present disclosure;

FIG. 5 is an implementation view III of the present disclosure;

FIG. 6 is an implementation view IV of the present disclosure;

FIG. 7 is a flow chart II of the method according to the present disclosure;

FIG. 8 is an implementation view V of the present disclosure;

FIG. 9 is an implementation view VI of the present disclosure;

FIG. 10 is an implementation view VII of the present disclosure;

FIG. 11 is an implementation view VI of the present disclosure; and

FIG. 12 is an implementation view VII of the present disclosure.

### DETAILED DESCRIPTION OF PREFERRED EMBODIMENTS

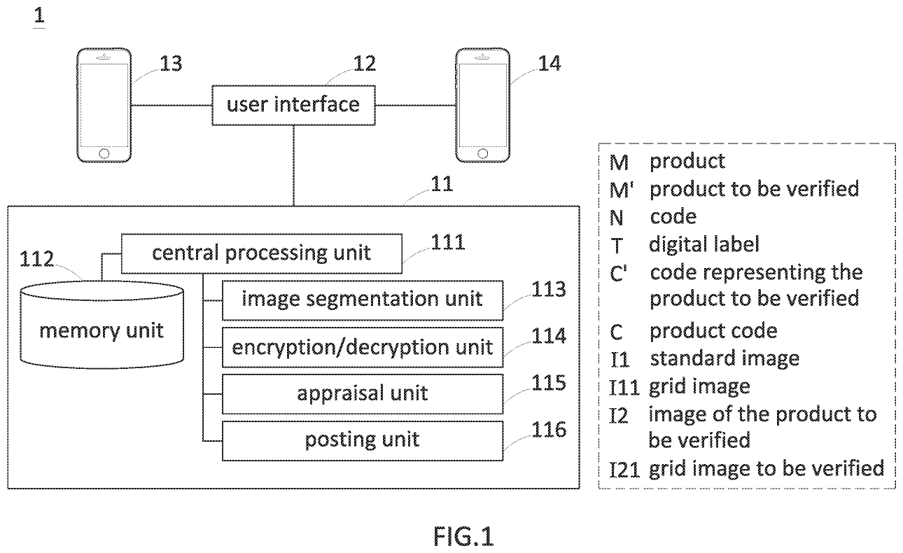

Referring to FIG. 1, a system 1 for a product anti-counterfeiting verification mechanism according to the present disclosure includes a server 11, a user interface 12 installed on the server 11, a first information device 13, and a second information device 14. The user interface 12 is in information connection with the first information device 13 and the second information device 14 respectively. The functions of each component are detailed as follows:

The server 11 includes a central processing unit 111. Meanwhile, a memory unit 112, an image segmentation unit 113, an encryption/decryption unit 114, an appraisal unit 115, and a posting unit 116. The central processing unit 111 is used to run the server 11 and to drive each unit informationally connected thereto. The central processing unit 111 fulfills functions such as logical operation, temporary storage of operation results, and storage of execution command positions. The central processing unit 111 is not limited to CPU. Any device that can manage and run the server 11 is applicable. The central processing unit 111 is provided for a code C′ representing the product to be verified to search for the same product code C stored in the memory unit 112 and to extract a grid image I11 corresponding to the product code C. Meanwhile, a grid image I21 to be verified is compared against the grid image I11 to generate a similarity. The genuineness of a product M can be determined by judging whether the similarity reaches a feature standard value. The comparison can be performed by one of the histogram calculation method, a hash algorithm, a cosine calculation method, a structural similarity (SSIM), or a combination thereof. Preferably, the feature standard value can be 95% similarity.

The memory unit 112 is used to store a plurality of product codes C, a feature grouping rule consisting of one or a combination of a segmentation rule, a sampling rule, and feature standard values, a standard image I1 and a plurality of grid images I11 corresponding to the product codes C. The memory unit 112 is selected from a group consisting of solid state disk or solid state drive (SSD), hard disk drive (HDD), static random access memory (SRAM), and random access memory (DRAM), etc.

The image segmentation unit 113 is used to perform a grid segmentation on the standard image I1 and an image I2 of the product to be verified based on the segmentation rule such that each standard image I1 is segmented into a plurality of grid images I11 and the image I2 of the product to be verified is segmented into a plurality of grid images I21 to be verified. For example, the segmentation is performed by 3×4 to form 12 grid images or by 5×5 to form 25 grid images.

The encryption/decryption unit 114 has a key. According to the feature grouping rule, the selected grid images I11 and codes N corresponding to the grid images I11 are combined to generate a product code C after the encryption operation program is performed with the key. Moreover, after decrypting the code C′ representing the product to be verified with the key, each selected code N can be extracted. After generating the product code C, the server 11 can write the product code C into a digital label T which can be integrated in the product M or in a certificate attached to the product M. The digital label T is a sensing label, a one-dimensional barcode, a two-dimensional barcode, an image barcode, or a combination thereof.

The appraisal unit 115 is used to perform an active appraisal on the product M. Moreover, the appraisal unit 115 can generate an appraisal price and a product information based on the appraisal price, and store it in the memory unit 112. Preferably, the product information contains product name, material, size, manufacturing information, sales history, etc.

The posting unit 116 enables the product information to be posted on the user interface 12. Preferably, each product must first pass a product-posting step or a product verification step before it is posted.

The user interface 12 is in informational connection with the first information device 13 and the second information device 14. Meanwhile, the user interface 12 is used to receive and transmit messages and information sent by the server 11, the first information device 13, and the second information device 14. In addition, the user interface 12 includes at least a purchase function button and a checkout function button. The way to establish an information connection can be achieved through data transmission protocols such as Ethernet, mobile network, Wireless-Fidelity, Wi-Fi, etc. The user interface 12 can be Web or App.

The first information device 13 and the second information device 14 are in information connection with the server 11. The second information device 14 is used to read a digital label T attached to a product M′ to be verified, so as to extract the code C′ representing the product to be verified. The first information device 13 is used to retrieve the standard image I1 of the product while the second information device 14 is used to retrieve the image I2 of the product to be verified. The first information device 13 and the second information device 14 fulfill a communication function and can respectively transmit the standard image I1 and the image I2 of the product to be verified to the server 11. The first information device 13 and the second information device 14 may be one of a smart phone, a tablet computer, a personal computer, or a notebook. The first information device 13 and the second information device 14 can be any device capable of receiving and transmitting messages sent by the user interface 12. The second information device 14 fulfils the function of Radio Frequency Identification (RFID), Near Field Communication (NFC), or a combination thereof and can read the product code in the digital label T.

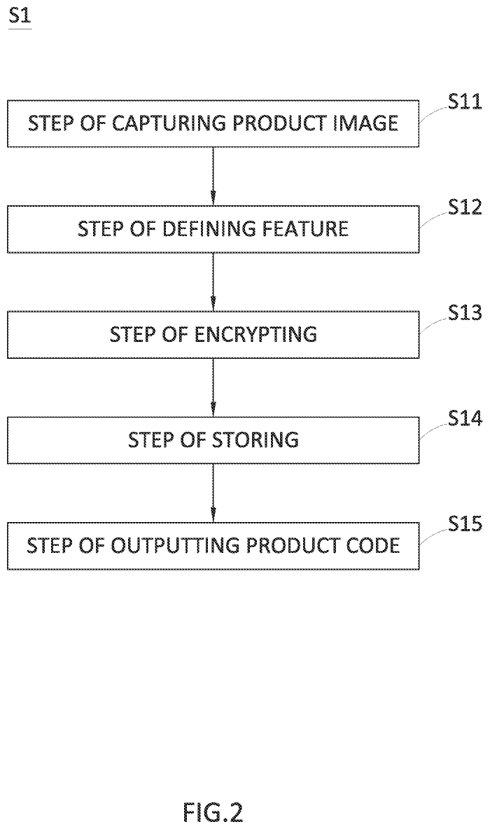

According to the method for a product anti-counterfeiting verification mechanism (see FIG. 2 together with FIG. 1), the commodity M is firstly processed through a step S1 of filing the product to establish the anti-counterfeiting verification mechanism. The step S1 is detailed as follows:

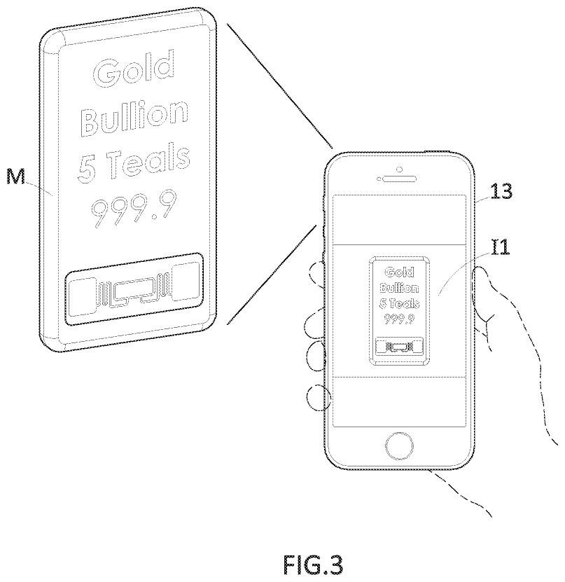

Step S11 of capturing a product image: Referring to FIG. 3, the first information device 13 captures images of the product M to create one or more standard images I1 and upload them to the server 11. The product M can be a 3C commodity, a peripheral commodity, a digital product, a home appliance product, a daily necessities, a food product, an outdoor product, a fashion product, a clothing, a decorative product, etc. It is understood that the product is not limited thereto. Preferably, the product M is a gold bar.

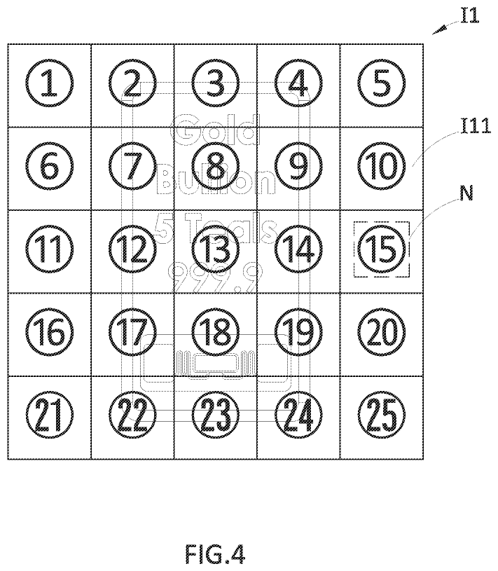

Step S12 of defining features. Referring to FIG. 4, the image segmentation unit 113 in information connection with the central processing unit 111 performs grid segmentation on each of the standard images I1 such that each of the standard images I1 is segmented into a plurality of grid images I11. Each of the grid images I11 is respectively defined with a code N. Preferably, the image segmentation unit 113 performs the grid segmentation on the standard image I1 based on the segmentation rule. The segmentation rule varies with the image such that the image segmentation unit 113 segments each of the grid images I11 with an equal portion according to the optimal grid. As shown in the drawing, the standard image I1 is segmented by the image segmentation unit 113 by 5×5 to form 25 grid images I11 and defined with the code N in the order of \textcircled{1}-\textcircled{25} from the upper left to the lower right.

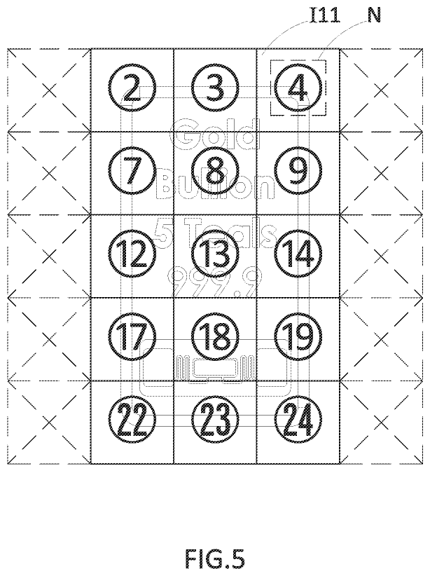

Optionally, the Step S12 of defining features includes a sub-step of removing each of the grid images I11 and its corresponding code N in which the product features cannot be identified (invalid feature). It is only necessary to keep the grid image I11 and the corresponding codes N that can identify the product features (effective features). As shown in FIG. 5, ten grid images I11 that cannot identify the product features and their corresponding codes N (\textcircled{1}, \textcircled{5}, \textcircled{6}, \textcircled{10}, \textcircled{11}, 15, 16, \textcircled{20}, \textcircled{21}, \textcircled{25}) are removed by the central processing unit 111 from the 25 grid images I11 with the code N. Meanwhile, the 15 grid images I11 that can identify product features and their corresponding codes N (\textcircled{2}-\textcircled{4}, \textcircled{7}-\textcircled{9}, \textcircled{12}-\textcircled{14}, \textcircled{17}-\textcircled{19}, \textcircled{22}-\textcircled{24}) remain and are not removed.

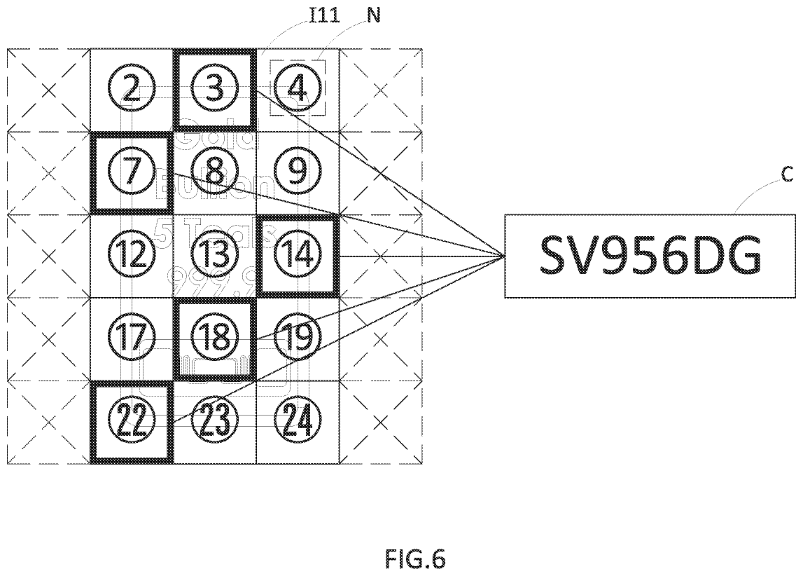

Step S13 of encrypting. Referring to FIG. 6, an encryption/decryption unit 114 in information connection with the central processing unit selects the plurality of grid images I11 according to the feature grouping rule and generates a product code C by combining the selected grid images I11 and the codes N corresponding to the grid images I11 after the encryption operation program with a key. According to feature grouping rules, including at least one or a combination of segmentation rules, sampling rules, and feature standard values, the five codes N (\textcircled{3}, \textcircled{7}, \textcircled{14}, \textcircled{18}, \textcircled{22}) and their corresponding grid images I11 are encrypted through the encryption/decryption unit 114 to generate a product code C whose serial number is SV956DG.

Step S14 of storing. The central processing unit 111 associates the product code C and its standard image I1. Meanwhile, the feature grouping rules, the product code C, the standard image I1, and each of the grid images I11 are stored in the memory unit 112 in information connection with the server 11. Preferably, after each of the grid images I11 is stored, the appraisal unit 115 in information connection with the central processing unit 111 performs an active appraisal on the product M to generate the product information with at least a price which is then posted by a posting unit 116 on the user interface 12 with which the server 11 is in information connection. Moreover, the user interface 12 includes at least a purchase function button and a checkout function button.

Step S15 of outputting product code. The product code C is written into the digital label T. The digital label T can be further integrated into the product M. Also, it can be a certificate attached to the product M. The digital label T is any one of an inductive label, a one-dimensional barcode, a two-dimensional barcode, an image-based barcode, or a combination thereof.

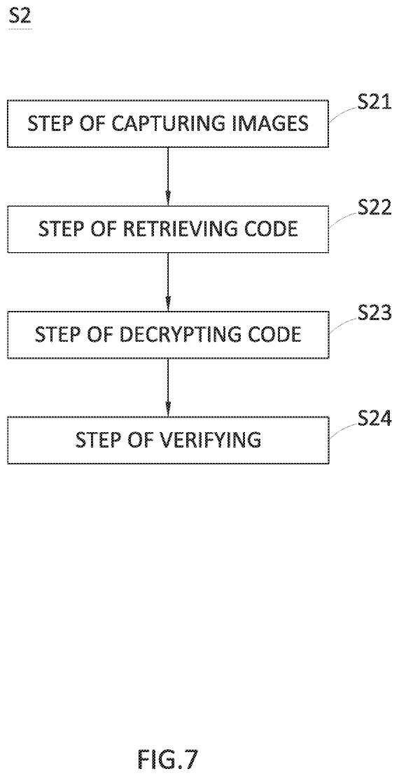

As mentioned above, after the step of storing is completed and if you buy a brand-new product in the first hand, or if you want to resell the product for auction, it is necessary to verify the authenticity of the product to confirm whether it is the genuine one. In this case, the step S2 of verifying product is detailed as follows (see FIG. 7 and FIG. 1):

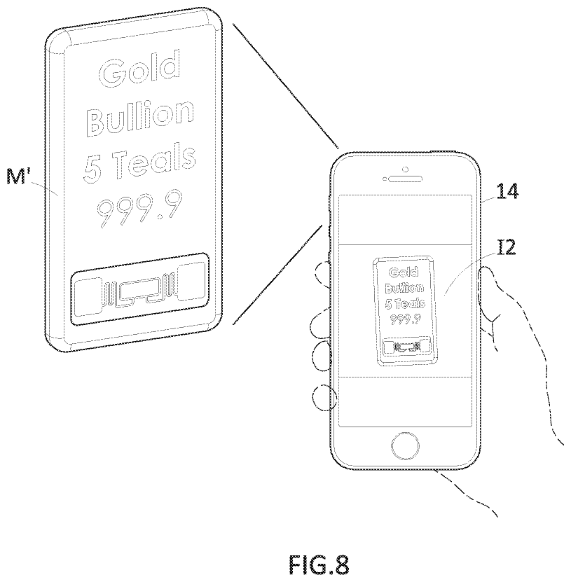

Step S21 of capturing images. Referring to FIG. 8, after executing the corresponding application program with the second information device 14, a step of capturing images of the product to be verified for obtaining an image I2 of the product to be verified. An App is installed on the server 11. The first information device 13 and the second information device 14 can transmit and receive information to/from the server 14 with the application program, and execute the instructions sent by the server 11. The server 11 stores an auxiliary image capture information. When the second information device 14 captures the product M′ to be verified, the server 11 displays an auxiliary photographing prompt on the user interface 12 based on the auxiliary image capture information. For example, the front, back, left, right, top, and bottom view of the product need to be taken to improve the accuracy in comparing features of the product.

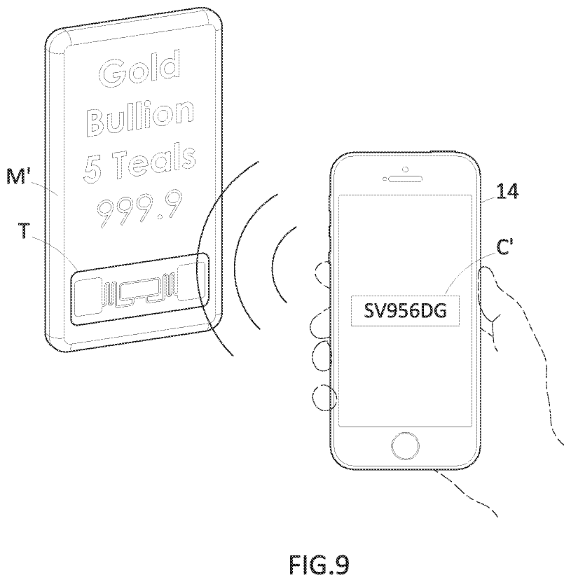

Step S22 of retrieving code: Referring to FIG. 9, the second information device 14 obtains a code C′ representing the product M′ to be verified by inputting, scanning, or sensing the digital label T of the product M′ to be verified. The second information device 14 further uploads the image I2 of the product to be verified and the code C′ representing the product to be verified to the server 11.

Step S23 of decrypting code: The encryption/decryption unit 114 compares the product code C stored in the memory unit 112 with the image I2 of the product to be verified and the code C′ representing the product to be verified. If, after comparison, the code C′ representing the product to be verified conforms to one of the product codes C, the encryption/decryption unit 114 decrypts the product code C with the key to extract the feature grouping rule corresponding to the product code C. Then, a step S24 of verifying is performed.

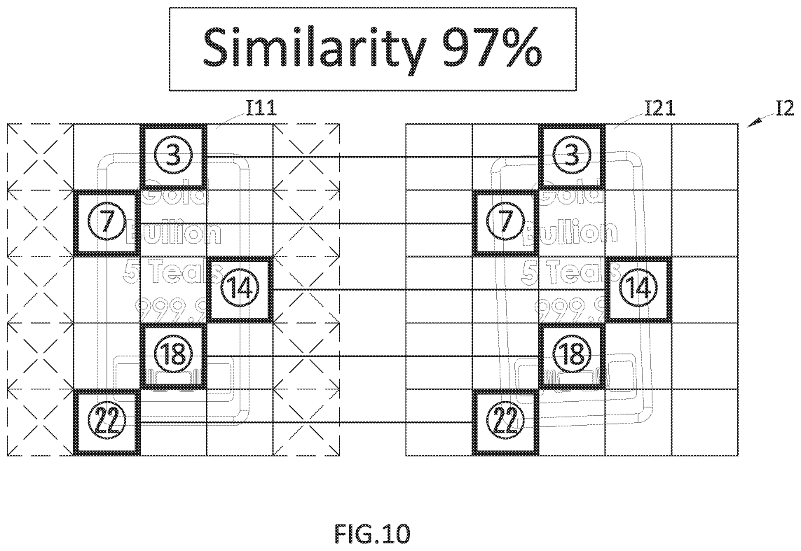

Step S24 of verifying: Referring to FIG. 10, the image segmentation unit 113 performs grid segmentation on the image I2 of the product to be verified according to the feature grouping rules, so as to generate a grid image I21 to be verified that conforms to the feature grouping rules. Then, according to the feature grouping rule, the selected grid image I11 is retrieved and compared against the grid image I21 to be verified. If the comparison result is match, the product M′ to be verified is the original of the product M. Preferably, the server 11 employs the feature standard value as the threshold. If the similarity of the comparison result is greater than the characteristic standard value, the comparison result is match. As shown in the drawing, the comparison unit 116 compares the grid images I11 (numbers: \textcircled{3}, \textcircled{7}, \textcircled{14}, \textcircled{18}, \textcircled{22}) with the grid images I21 to be verified (numbers: \textcircled{3}, \textcircled{7}, \textcircled{14}, \textcircled{18}, \textcircled{22}). The 97% similarity is created. If it is higher than the feature standard value, it is determined that the product M′ to be verified is genuine.

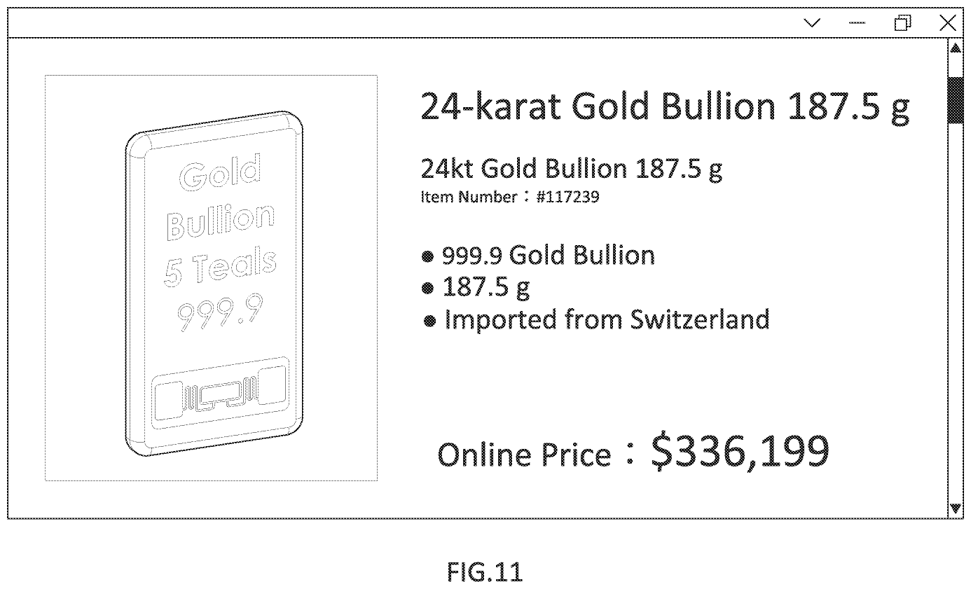

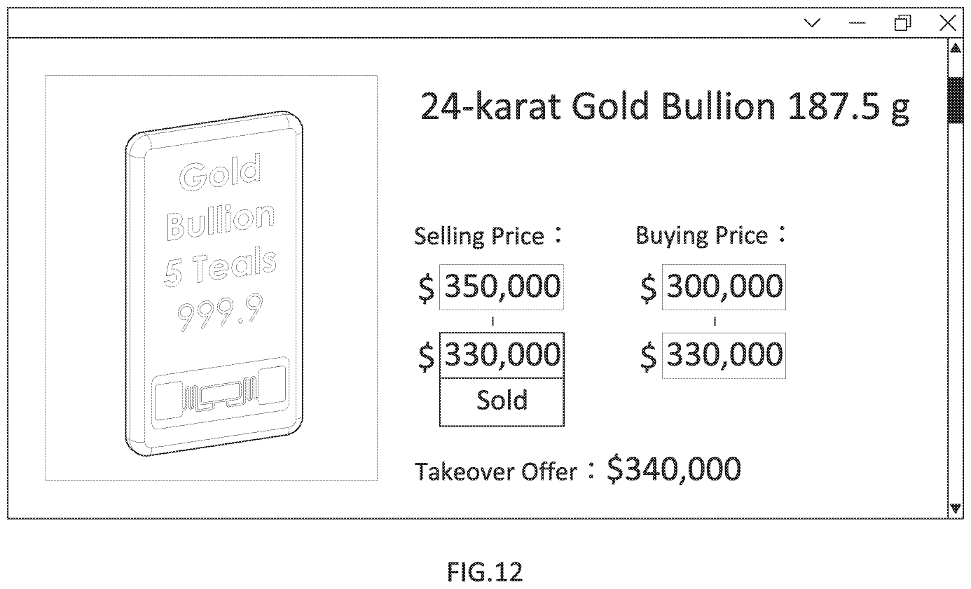

Referring to FIG. 11, when a seller wants to sell the product M′ to be verified for auction, it needs to go through the step S24 of verifying. After going through the step S24 of verifying, the verified product can be posted for sale, and the seller can set an auction price. As shown in FIG. 12, the server 11 includes an appraisal unit 115 that is in information connection with the central processing unit 111 and can actively appraise the product M to generate product information with at least the appraisal price. The appraisal unit 115 can generate appraisal prices for the products posted for sale by the sellers. When the appraisal price of the product is higher than the auction price, the server 11 will purchase the product M which is posted by the posting unit 116 at the appraisal price.

As mentioned above, the buyer may use the second information device 14 to execute the function of placing an order through the purchase function button and the function of settlement and payment through the checkout function button on the user interface 12. To verify the authenticity of the purchased product M′ to be verified and to confirm whether it is the original of the product M, the second information device 14 can execute the step S24 of verifying to ensure that the purchased product is genuine.

According to the present disclosure, the method and the system for a product anti-counterfeiting verification mechanism can effectively establish the anti-counterfeiting verification of the product M, so that consumers can verify the product when they buy a new product, or when the consumers want to post the product M for resale, or another consumer buy products for resale. In other words, the system 1 can effectively confirm the authenticity of the product M. In order to clearly express the technical characteristics of the present disclosure, the following four examples are used for description.

1. Before a brand-new product A is posted for sale, the product anti-counterfeiting information can be established through the step S1 of filing the product, which can be used as the basis of the authenticity of the product for the buyer or for the seller in case of resale in the future.

2. When a consumer C buys and sells this brand-new product A, he can confirm through the step S2 of verifying product whether the product A is registered and check its product information.

3. When the consumer C wants to resell the purchased product A, he can first verify the authenticity of the product A through the step S2 of verifying product. This verifying process can be used for products pre-launched by each e-commerce platform and trading platform.

4. When another consumer D buys the product A sold by the consumer C, the consumer D can perform the step S2 of verifying product to confirm whether the product A is genuine and to check the product information.

According to the present disclosure, the system for a product anti-counterfeiting verification mechanism includes the server, the user interface, the first information device, and the second information device. In performing the step of filing product, the server obtains the standard image of the product through the first information device, and successively segment it to generate a plurality of grid images, and further encodes the product code representing the product, so as to complete the registration, the anti-counterfeiting verification of the product and the collection of the product information. When buyers and sellers launch the product for auction and performs the authenticity verification operations in the future, the second information device can obtain the image of the product to be verified, and obtain the product code from the digital label attached to the product, and then send it to the server. Then, the corresponding selected grid image is extracted from the product code, and the similarity comparison with the selected grid image to be verified is further conducted to check with the authenticity. Accordingly, the method and the system for a product anti-counterfeiting verification mechanism can use image encryption and decryption technology to obtain the product code. Meanwhile, the standard image of the product is compared against the image of the product to be verified through the product code to ensure that the product is genuine.

### REFERENCE SIGN

1 method and system for a product anti-counterfeiting verification mechanism
11 server
12 user interface
13 first information device
14 second information device
111 central processing unit
112 memory unit
113 image segmentation unit
114 encryption/decryption unit
115 appraisal unit
116 posting unit
S1 step of filing product
S11 step of capturing a product image
S12 step of defining features
S13 step of encrypting
S14 step of storing
S15 step of outputting product code
S2 step of verifying product
S21 step of capturing images
S22 step of retrieving code
S23 step of decrypting code
S24 step of verifying
I1 standard image
I2 image of the product to be verified
I11 grid image
I21 grid image to be verified
C product code
C′ code representing the product to be verified
M product
M′ product to be verified
N code
T digital label

What is claimed is:

1. A method for a product anti-counterfeiting verification mechanism with a server having a central processing unit to verify an authenticity of a product, comprising steps of:
capturing a product image, wherein a first information device captures an image of the product and generates one or more standard images, which are then uploaded to the server;
defining features, wherein an image segmentation unit in information connection with the central processing unit performs a grid segmentation on each of the standard images such that each of the standard images is segmented into a plurality of grid images, and each of the grid images is assigned separately with a code;
encrypting, wherein an encryption/decryption unit in information connection with the central processing unit selects a plurality of the grid images according to a feature grouping rule, and wherein the selected grid images and the codes corresponding to the grid images are combined with a key to generate a product code through an encryption operation process; and
storing, wherein the central processor associates the product code with the standard image, and wherein the product code, the standard images, each of the grid images, and the feature grouping rule are stored in a memory unit in information connection with the server.

2. The method for the product anti-counterfeiting verification mechanism as claimed in claim 1, wherein the feature grouping rule includes at least one of a sampling rule, a feature standard value, or a combination thereof.

3. The method for the product anti-counterfeiting verification mechanism as claimed in claim 2, wherein the feature grouping rule further includes a segmentation rule, and the image segmentation unit performs the grid segmentation based on the segmentation rule.

4. The method for the product anti-counterfeiting verification mechanism as claimed in claim 1, further comprising a step of outputting a product code after the product code is generated, wherein the product code is written into a digital label which is integrated in the product or in a certificate attached to the product, and wherein the digital label is a sensing label, a one-dimensional barcode, a two-dimensional barcode, an image barcode, or a combination thereof.

5. The method for the product anti-counterfeiting verification mechanism as claimed in claim 3, wherein, after the step of storing is completed, the following steps are performed for conducting an authenticity verification on a product to be verified:
capturing images, wherein a corresponding application program is executed with a second information device for performing an image capturing process on the product to be verified to obtain an image of the product to be verified;
retrieving code, wherein a code representing the product to be verified is extracted from the digital label by the second information device, and the second information device further uploads the image of the product to be verified and the code representing the product to be verified to the server;
decrypting code, wherein the encryption/decryption unit compares the image of the product to be verified and the code representing the product to be verified against the product codes and each of the standard images stored in the memory unit, and wherein if the code representing the product to be verified matches one of the product codes after comparison, a next step of verifying is performed; and
verifying, wherein the central processing unit performs grid segmentation on the image of the product to be verified by the image segmentation unit according to the feature grouping rule, so as to generate a grid image to be verified that conforms to the feature grouping rule; whereupon, according to the feature grouping rule, the selected grid image is extracted to compare against the grid image to be verified, and wherein, when the comparison result is match, the product to be verified is the original of the product.

6. The method for the product anti-counterfeiting verification mechanism as claimed in claim 5, wherein, when the second information device captures the product to be verified in the step of capturing images, the server displays an auxiliary photographing prompt on the user interface based on an auxiliary image capture information.

7. The method for the product anti-counterfeiting verification mechanism as claimed in claim 1, wherein an appraisal unit in information connection with the central processing unit performs an active appraisal on the product to generate the product information with at least an appraisal price which is then posted by a posting unit on the user interface with which the server is in information connection, and wherein the user interface includes at least a purchase function button and a checkout function button.

8. The method for the product anti-counterfeiting verification mechanism as claimed in claim 7, wherein the second information device is used to execute the function of placing an order through the purchase function button and the function of settlement and payment through the checkout function button on the user interface, and wherein in verifying the authenticity of a purchased product to be verified and to confirm whether it is the original of the product M, a process to capture an image of the product to be verified is performed after execution of a corresponding application program via the second information device, such that the image of the product to be verified is obtained, whereupon the second information device is used to extract a code representing the product to be verified from the digital label, and the second information device further uploads the image of the product to be verified and the code representing the product to be verified to the server;
wherein the encryption/decryption unit compares the image of the product to be verified and the code representing the product to be verified against each of the product codes and the standard images stored in the memory unit, and wherein if the code representing the product to be verified matches one of the product codes after comparison, a next step of verifying is performed; and
wherein the central processing unit performs grid segmentation on the image of the product to be verified by the image segmentation unit according to the feature grouping rule, so as to generate a grid image to be verified that conforms to the feature grouping rule; whereupon, according to the feature grouping rule, the selected grid image is extracted to compare against the grid image to be verified, and wherein, when the comparison result is match, the product to be verified is the original of the product.

9. A system for a product anti-counterfeiting verification mechanism, comprising:
a server having a central processing unit for receiving an image of a product captured by a first information device so as to generate a standard image;
an image segmentation unit being in information connection with the central processing unit for performing a grid segmentation on the standard image, such that the standard image is segmented into a plurality of grid images, and each of the grid images being respectively assigned with a code;
an encryption/decryption unit being in information connection with the central processing unit for selecting a plurality of the grid images according to the feature grouping rule, each of the selected grid images and the codes corresponding to the grid images being combined with a key to generate a product code after an encryption operation process; and
the product code, the standard images, each of the grid images, and the feature grouping rule being stored in a memory unit.

10. The system as claimed in claim 9, wherein the standard image is generated by the first information device that captures the image of the product, and the first information device has a communication function for transmitting the generated standard image to the server.

11. The system as claimed in claim 9, wherein the product code is written by the server into a digital label which is integrated in the product or in a certificate attached to the product, and wherein the digital label is a sensing label, a one-dimensional barcode, a two-dimensional barcode, an image barcode, or a combination thereof.
